(19) United States
(12) Patent Application Publication
(10) Pub. No.: US 2013/0075566 A1
(43) Pub. Date: Mar. 28, 2013

(54) Storage for USB Flash Drives

(71) Applicant: Stephen Grant, Malvern (AU)

(72) Inventor: Stephen Grant, Malvern (AU)

(73) Assignee: MACLAW NO. 477 PTY LTD, Victoria (AU)

(21) Appl. No.: 13/623,462

(22) Filed: Sep. 20, 2012

(30) Foreign Application Priority Data
Sep. 22, 2011 (AU) 2011903903

(51) Int. Cl. F16M 11/00

(52) U.S. Cl. CPC F16M 11/00
USPC 248/346.03

(57) ABSTRACT

A stand for storing a plurality of USB flash drives, the stand comprising a block having in its surface a plurality of slots each of a configuration to receive the connector of a USB drive whereby the body of the drive extends in an upright manner from the block, and a plurality of posts each of a configuration for fitting into a protective cap for the connector whereby the caps of the associated USB drive can be stored in an upright manner from the block by engagement onto the posts.

### CROSS-REFERENCE TO RELATED APPLICATIONS

This application claims the benefit and priority of Australian Provisional Application No. 2011903903, filed Sep. 22, 2011. The entire disclosure(s) of the above application is incorporated herein by reference.

### FIELD

The present disclosure relates to a stand for storing USB flash drives.

### SUMMARY

This section provides a general summary of the disclosure, and is not a comprehensive disclosure of its full scope or all of its features.

According to the invention there is provided a stand for storing a plurality of USB flash drives, the stand comprising a block having in its surface a plurality of slots each of a configuration to receive the connector of a USB drive whereby the body of the drive extends in an upright manner from the block, and a plurality of posts each of a configuration for fitting into a protective cap for the connector whereby the caps of the associated drives can be stored in an upright manner from the block by engagement onto the posts.

In a preferred embodiment, the slots and posts are arranged in parallel rows with each post and associated slot being in alignment and advantageously the surface of the block has a zone associated with each slot and on which data can be written.

Advantageously the block includes means for connecting a like block in side-to-side or end-to-end relation whereby the block forms a component of a modular system for providing a stand of enlarged capacity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a stand for a USB flash drive or memory stick;

FIG. 2 is a perspective view showing memory sticks and their protective caps stored on the stand;

FIG. 3 is a section on line A-A of FIG. 2;

FIG. 4 is a perspective view showing a group of such stands assembled in side-to-side and end-to-end relation; and

FIG. 5 is a cross-section through the assembly of FIG. 4.

Corresponding reference numerals indicate corresponding parts throughout the several views of the drawings.

### DETAILED DESCRIPTION

Example embodiments will now be described more fully with reference to the accompanying drawings.

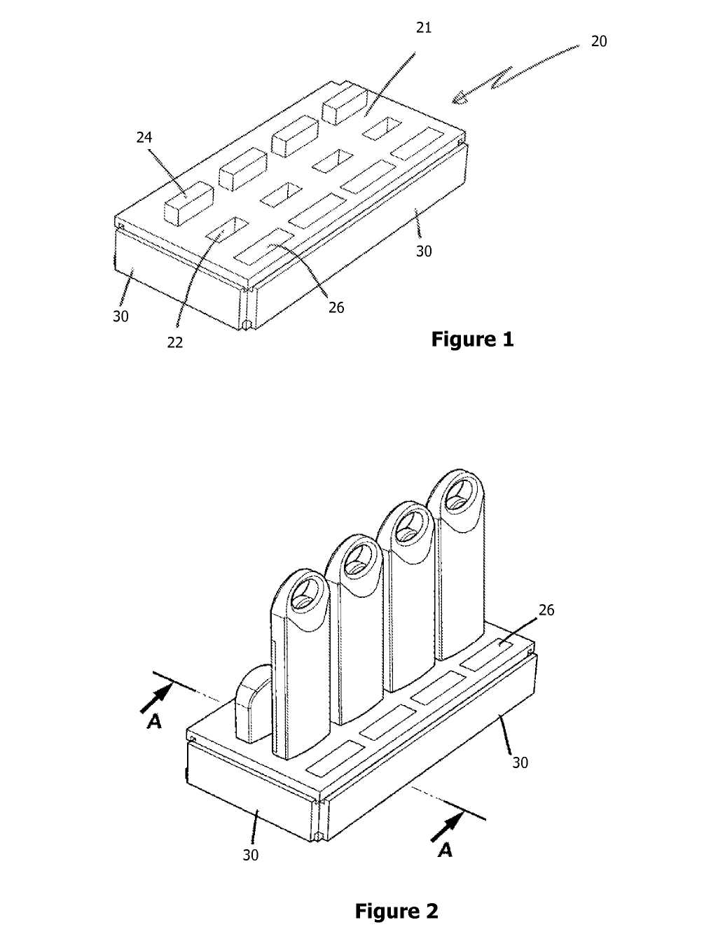

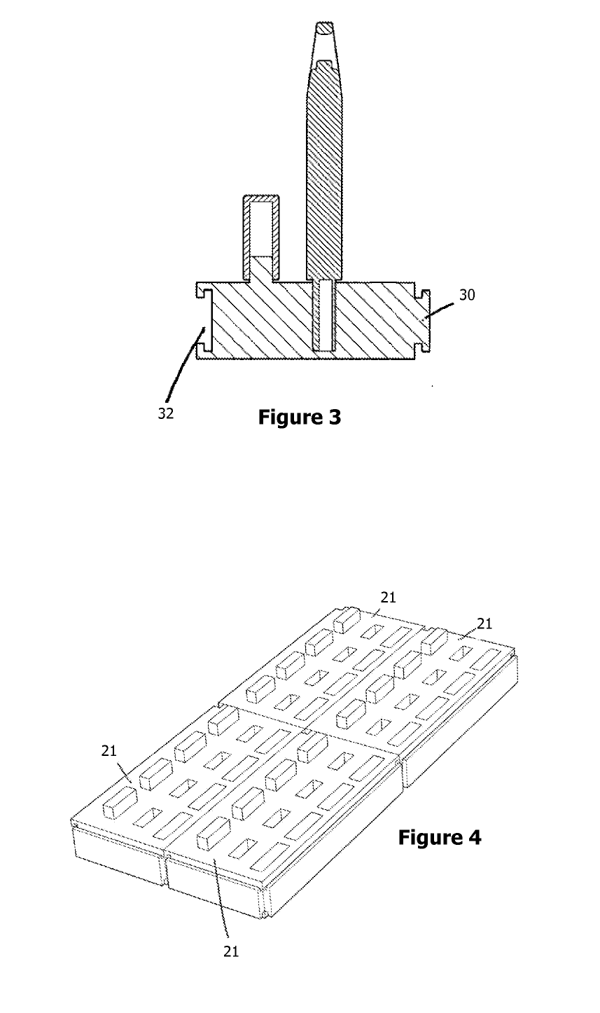

FIGS. 1 to 3 show an embodiment of a stand 20 for storing USB flash drives, sometimes referred to as memory sticks for ready accessibility in a work area or the like. The stand 20 consists of a block 21 preferably in the form of a one-piece plastic moulding consisting of a row of slots 22 of a size to receive the connector of a USB stick so that the stick will be supported upright from the upper surface of the block 21 with its connector engaged within the slot as shown in FIGS. 2 and 3. Parallel with the row of slots 22 is a row of upstanding posts 24 having a cross-sectional configuration of a size to receive a protective cap for the connector as may be supplied with many types of USB stick. As the connector itself is of a standard dimension, so is the interior of the protective cap and hence a standard size of post will be able to mount any protective cap in an upright manner from the upper surface of the block as shown in FIGS. 2 and 3. The upstanding posts 24 are arranged on the block 21 in a row parallel to the row of slots 22 with each post 24 being aligned with, and thereby associated with, one of the slots 22. In front of the row of slots is a row of plane areas 26, as shown rectangular, and of a form which can receive written data for example to identify the contents of the USB stick stored in the associated slot. The areas 26 preferably have a white or light background to enable the data easily to be read and are preferably such that they can be overwritten either in pencil or pen which can be subsequently removed by wiping. In the embodiments shown the block is configured to provide a storage for a row or four USB sticks and their associated caps.

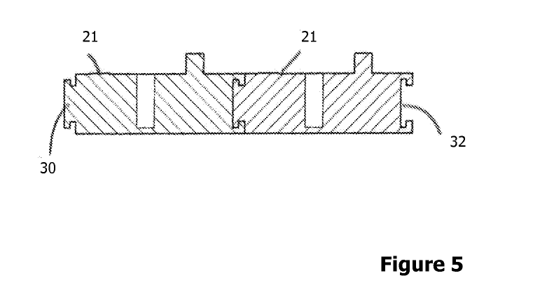

While the block 21 could be configured for storage of substantially more than four USB sticks and associated caps for example by forming the block with two or more rows of slots, posts, and associated indicia areas, it is particularly preferred for the block 21 to constitute one component of a modular storage system by whereby two or more such blocks can be assembled together to increase the storage capacity. For this purpose, the block 21 has at each of its edges one part of a mating two part connector whereby two or more such blocks can be connected in side-to-side or end-to-end configuration. In the particular embodiment shown, the block has along one of its sides and on one of its ends a connector 30 of undercut cross-section and along its opposite side and end a groove 32 (see FIG. 3) of a corresponding cross-section for engagement by the connector 30 along the side or end of a second, like, block by sliding the connector 30 of one block into the groove 32 of the other block whereby the two blocks are rigidly connected. The connector 30 thereby constitutes the male part and the groove 32 the female part of a mating two-part connector. FIG. 4 shows an enlarged stand formed by coupling four of the individual blocks 2; the cross-section of FIG. 5 shows the mating connection between two of the blocks in side-by-side relation.

While one particular form of two part male/female connection system has been shown it will be understood that a variety of other connectors would be suitable for this purpose.

The embodiments have been described by way of example only and modifications are possible within the scope of the invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A stand for storing a plurality of USB flash drives, the stand comprising a block having in its surface a plurality of slots each of a configuration to receive the connector of a USB drive whereby the body of the drive extends in an upright manner from the block, and a plurality of posts each of a configuration for fitting into a protective cap for the connector whereby the caps of the associated USB drive can be stored in an upright manner from the block by engagement onto the posts.

2. A stand according to claim 1, wherein the slots and posts are arranged in parallel rows with each post and associated slot being in alignment.

3. A stand according to claim 2, wherein the block has associated with each slot a surface zone on which data can be written.

4. A stand according to claim 2, wherein the block includes a system for connecting a like block in side-to-side or end-to-end relation whereby the block forms a component of a modular system for providing a stand of enlarged capacity.

5. A stand according to claim 4, wherein the connecting system comprises male components of mating two-part connectors along a first side and first end of the block, and female components of the mating two-part connectors along a second side and second end of the block.

6. A stand according to claim 5, wherein the block has associated with each slot a surface zone on which data can be written.
